(19) United States
(12) Patent Application Publication
(10) Pub. No.: US 2026/0264885 A1
(43) Pub. Date: Sep. 10, 2026

(54) DEVICE FOR LAUNCHING A PROJECTILE AND METHOD FOR LAUNCHING A PROJECTILE

(71) Applicant: Loïs LABARRÈRE, Saint-Yaguen (FR)

(72) Inventor: Loïs LABARRÈRE, Saint-Yaguen (FR)

(21) Appl. No.: 19/168,153

(22) PCT Filed: Mar. 21, 2024
(86) PCT No.: PCT/EP2024/057690

§ 371 Date: Sep. 23, 2025

(30) Foreign Application Priority Data
Mar. 24, 2023 (FR) FR2302853

(51) Int. Cl. B64G 1/00

(52) U.S. Cl. CPC B64G 1/002

(57) ABSTRACT

A device for launching a projectile includes a chamber provided with a side wall and an ejection port. An arm is mounted rotating around a rotation shaft in the chamber. A pad is fixed to the arm and receives the projectile. The pad moves circularly in the chamber. The pad comprises a nozzle connected to a source of a first gas to eject a flow of first gas and make the pad advance inside the chamber. The side wall defines a track supporting the pad in a radial direction. The track, pad and a second gas define an aerodynamic bearing between the track and pad so that the track takes up at least a part of the stresses of the pad in the radial direction.

### BACKGROUND OF THE INVENTION

The invention relates to a device for launching a projectile and to a method for launching a projectile.

### PRIOR ART

To access the stratosphere or the upper layers, the force of gravity has to be overcome. It is known to use space launchers that deliver a large thrust force due to the ejection of a gas. The gas is expelled in great quantity and with a high velocity to outside the launcher. To obtain this result, a large quantity of fuel is embarked in the launcher also called shuttle, and a chemical reaction is initiated to obtain production of the gas that will be ejected.

This technical solution is not advantageous as the natural resources are depleted, so that the large quantity of fossil energy consumed each time a launcher is used will lead to a considerable increase of its operating costs. Sending a launcher into space results in the emission of a large quantity of carbon dioxide CO₂ and ejection of black carbon particles that may modify the optical properties of the atmosphere. A large part of the mass to be displaced corresponds to the fuel that has not yet reacted. It is also noteworthy that combustion of the fuel results in a considerable discharge in the different layers of the atmosphere. As the frequency of use of launchers is continuously rising, the carbon dioxide content and the effect of the launchers on the optical properties of the atmosphere are increased.

In a very large majority of cases, the launchers are one-time use launchers, which makes this technology particularly resource-consuming. When the launcher is said to be reusable, only a few parts of the latter can be reused and only after a substantial refurbishment operation. Furthermore, reuse of the parts of the launcher is limited to a small number of launches thereby limiting the economic interest of this route.

To replace conventional launchers on all or part of their market, it is known to use electromagnetic catapults or mass accelerators that are configured to accelerate a projectile such as a satellite to reach speeds enabling the projectile to reach or pass through the stratosphere.

The mass is accelerated until its kinetic energy is sufficient to counteract the efforts of friction and gravity and for the projectile to reach at least the stratosphere. The projectile is ejected without being associated with a chemical propulsion reactor that propels the latter from the ground up through the troposphere. These technologies are particularly advantageous as the launch system remains on the ground so that the mass to be launched is reduced. The launch system is mainly reusable thereby limiting the costs of a launch.

The document WO2014/124431 discloses a launching system provided with an ejection track in the form of a spiral. The spiral is mounted on an inclinable platform in order to adjust the ejection angle of the projectile. The projectile is installed on a shoe that is curved to match the curvature of the spiral track. The projectile is covered with a fuel component arranged over the length thereof. The fuel generates a gas pressure between the fuel and the curved track to create a centripetal force that partially or totally opposes the centrifugal force related to acceleration. Generation of gas reduces the friction and the heat rise between the projectile and the track. The projectile is accelerated by gyration of the whole of the track by means of gyration motors. This technical solution is not optimal. It requires the consumption of a great deal of energy as the whole of the track has to be displaced. The useful payload able to be launched is consequently light.

The document U.S. Pat. No. 10,202,210 discloses a circular system for accelerating a projectile. The projectile is arranged at one end of a rotatable arm mounted rotating around a rotation shaft. The other end of the rotatable arm is provided with a counterweight the mass of which is chosen according to the weight of the projectile. A motor makes the arm rotate at increasingly high speed until the projectile reaches the required speed. The projectile is then disconnected from the arm and exits the circular platform via an ejection port. In order to limit the friction forces during acceleration of the projectile, the platform is in the form of a chamber placed in a vacuum.

This technical solution presents a certain number of limitations that appear prohibitive as regards commercial operation. In a first instance, rotation of the arm is obtained by means of a motor supplied by electricity, which imposes the use of a phenomenal quantity of electric power to send a projectile into space.

The centrifugal force applied on the arm progresses with the square of the tangential speed of the projectile and with the mass of the projectile. This means that obtaining high tangential speeds to obtain a high kinetic energy necessary for placing in orbit goes hand in hand with applying an enormous centrifugal force on the rotation arm. A rotation arm dimensioned to withstand the enormous mechanical stresses applied then has to be used, and the same is the case for the majority of the components participating in rotation of the arm.

As the speed of rotation progressively increases, the forces applied on the arm increase and the latter tends to be distorted so that the projectile tends to move towards the side wall of the platform. The arm is configured to limit the distortion as far as possible. It is apparent that the configuration of the arm as disclosed in the document U.S. Pat. No. 10,202,210 is not the most advantageous to reach high tangential speeds with heavy projectiles.

### OBJECT OF THE INVENTION

One object of the invention consists in providing a device for launching a projectile that tends to address the above-mentioned issues and in particular that is better suited to high speeds of rotation and/or to heavy projectiles, while at the same time remaining easy to implement.

These issues tend to be solved by means of a device for launching a projectile comprising:
a chamber provided with a side wall and an ejection port;
a rotation arm mounted rotatable around a rotation shaft, the rotation arm being arranged to rotate around the rotation shaft in the chamber, the rotation arm extending in a radial direction;
a pad installed at a first end of the rotation arm and designed to receive the projectile, the pad moving with a circular movement in the chamber.

The launching device is remarkable in that the pad comprises a nozzle connected to a source of a first gas, the nozzle ejecting a flow of first gas directed to make the pad advance with the circular movement inside the chamber;

in that the side wall defines at least one track designed to support the pad in the radial direction;

in that the at least one track, the pad and a second gas define an aerodynamic bearing between the at least one track and the pad so that the at least one track takes up at least a part of the stresses of the pad in the radial direction;

in that it comprises a pumping system configured to suck up the first gas and the second gas to place the inside of the chamber in a vacuum.

In advantageous manner, the source of first gas is a source located outside the chamber and connected to the pad by a pipe fixed to the rotation arm.

In a particular configuration, the source of first gas is arranged immobile with respect to the chamber or immobile with respect to a support supporting the chamber.

In an advantageous development, the source of first gas comprises a compressor configured to eject the first gas at a pressure at least equal to 106 Pa.

Preferentially, the side wall defines a bottom track and a top track separated from one another in a direction parallel to a rotational axis of the rotation arm defined by the rotation shaft. The nozzle is arranged to eject the first gas against a surface located between the bottom track and the top track.

According to one embodiment, the pad comprises a bottom plate and a top plate running respectively facing the bottom track and the top track, the bottom plate and top plate defining two walls that are non-parallel and secant of convex shape starting from the rotation shaft.

In an advantageous development, the rotation arm is flexible in a direction parallel to the rotational axis of the rotation shaft.

In a particular embodiment, the bottom track and top track are tracks salient from the side wall delineating a confinement groove of the first gas outlet from the nozzle.

Preferentially, the pad comprises a bottom plate and a top plate running respectively facing the bottom track and the top track, the pad having a plate extending continuously from the bottom track to the top track.

In another advantageous development, the launching device comprises a discharge pipe of the first gas that extends the nozzle and confines the first gas jet, the nozzle being directed in such a way as to generate a flow of first gas that is perpendicular to the radial direction, a central axis of the flow of first gas ejected by the nozzle being included in the plane defined by a neutral fibre of the rotation arm.

Preferentially, the device for launching a projectile comprises a plate fixed to the discharge pipe to enclose the nozzle, the plate covering the bottom track and the top track to form a first additional aerodynamic bearing with the bottom track and a second additional aerodynamic bearing with the top track, the plate defining an aperture for removal of the first gas.

In advantageous manner, the side wall comprises a plurality of partially overlapping fins, and wherein each pair of two consecutive fins, the top track and the bottom track forming a tube connected to the pumping system.

Preferentially, the launching device comprises a generator of a second gas that is the generator of the first gas, and wherein a part of the flow of first gas is directed between the pad and the track.

Advantageously, one of the pad and track is covered by a sacrificial material sublimating the second gas in response to a heat input originating from running of the pad facing the track.

Preferentially, the sacrificial material is arranged along the bottom track and the top track.

The sacrificial material can be a polytetrafluoroethylene or a polycarbonate.

Preferentially, the rotation arm and the pad form a mechanical connection allowing movement of the pad with respect to the rotation arm in the radial direction of the rotation shaft.

It is a further object of the invention to provide a method for launching a projectile that is more efficient than the methods of the prior art, for example enabling launching of heavier projectiles and/or at higher speeds.

This result tends to be achieved by means of a method for launching a projectile comprising the following steps:
providing a launching device according to any one of the above configurations;
securing the projectile to the pad;
reducing the pressure in the chamber;
driving the pad in rotation until a threshold ejection speed is reached;
releasing the projectile so that the projectile exits the launching device with the threshold speed through an ejection port.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1: a perspective view of a launching device;

FIG. 2: another view of a launching device with the angle of inclination between the chamber and a reference plane;

FIG. 3: a partial sectional view of the chamber with the rotation arm;

FIG. 4: a sectional view of the chamber with the rotation arm along the rotational axis of the arm;

FIG. 5: an elevational view of the rotation arm with a pad receiving a projectile;

FIG. 6: a perspective view of a pad comprising a projectile;

FIG. 7: a view of a pad comprising a projectile along a radial axis of travel of the pad in the chamber;

FIG. 8: a side view of the pad in a direction representing the tangential component of travel of the pad;

FIG. 9: a side view of the pad receiving a projectile along the rotational axis of the rotation arm;

FIG. 10: a side view of the pad arranged on the track of the chamber along the rotational axis of the rotation arm;

FIG. 11: a perspective view of the pad arranged on two tracks of the chamber;

FIG. 12: a perspective view of a discharge pipe;

FIG. 13: a perspective view of the side wall of the chamber;

FIG. 14: a top view of the rotation arm defining the slide link;

FIG. 15: a side view of the flexibly-mounted rotation arm.

### DESCRIPTION DES MODES DE RÉALISATION

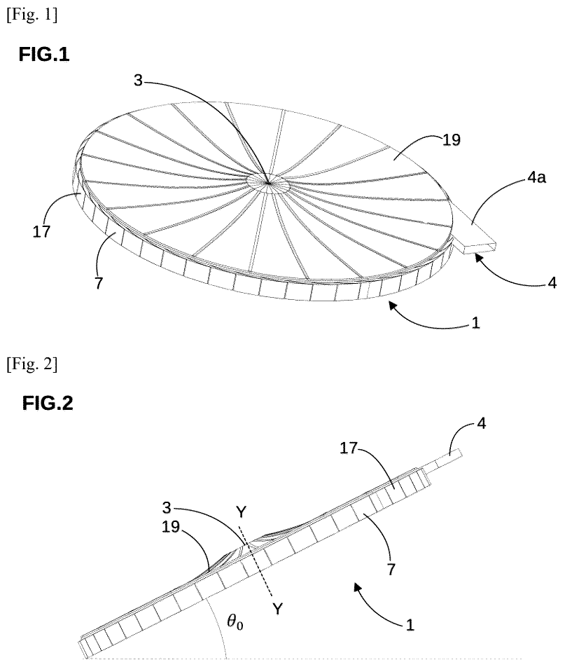

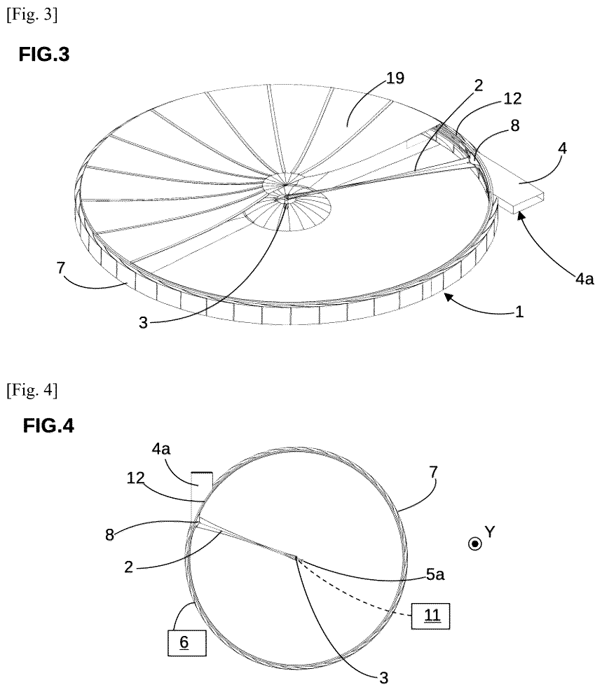

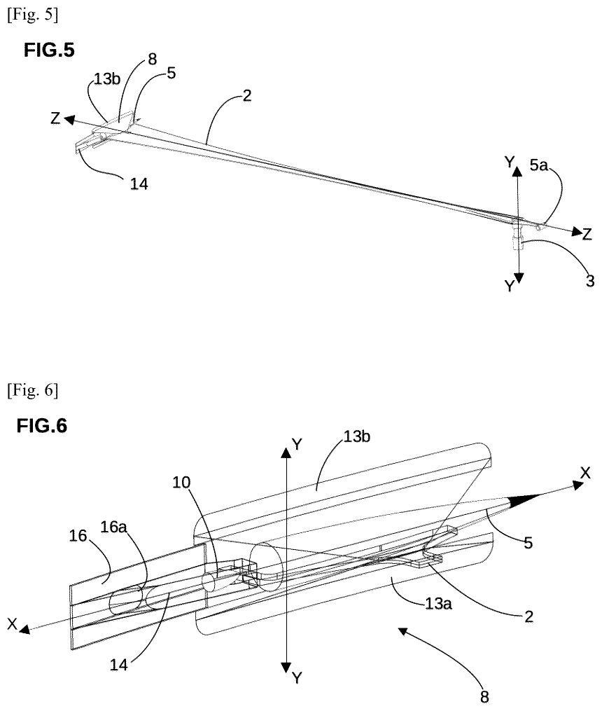

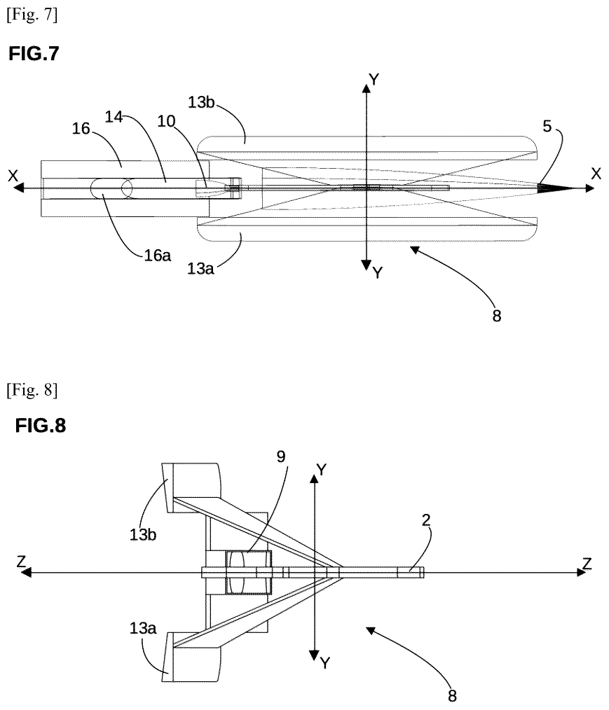

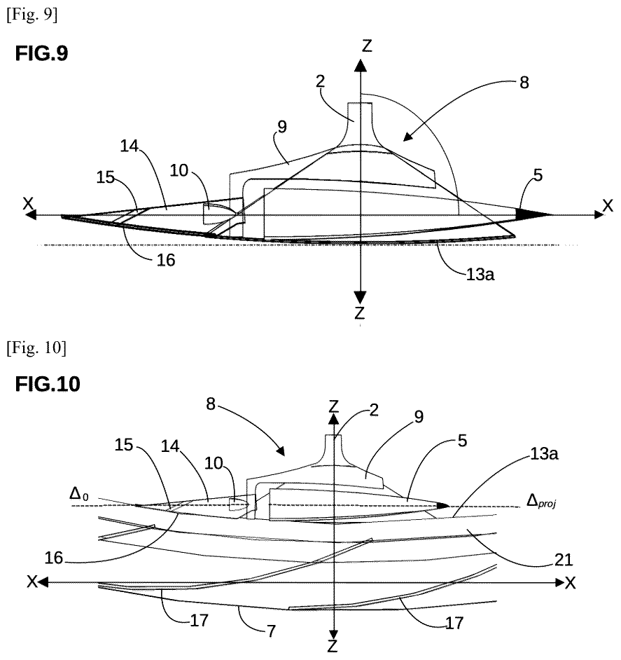

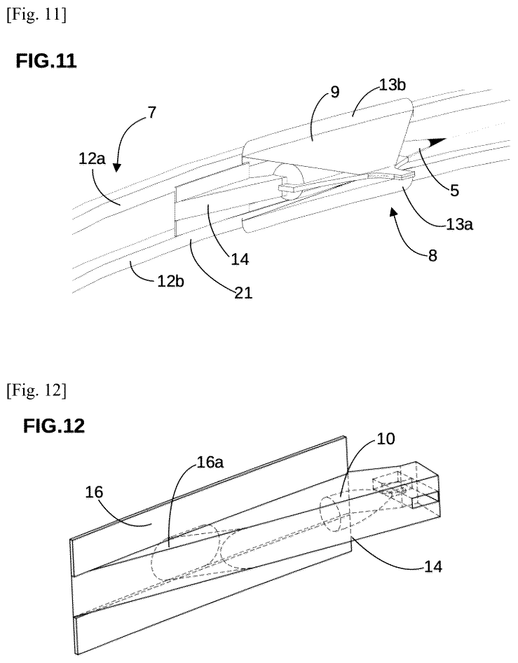

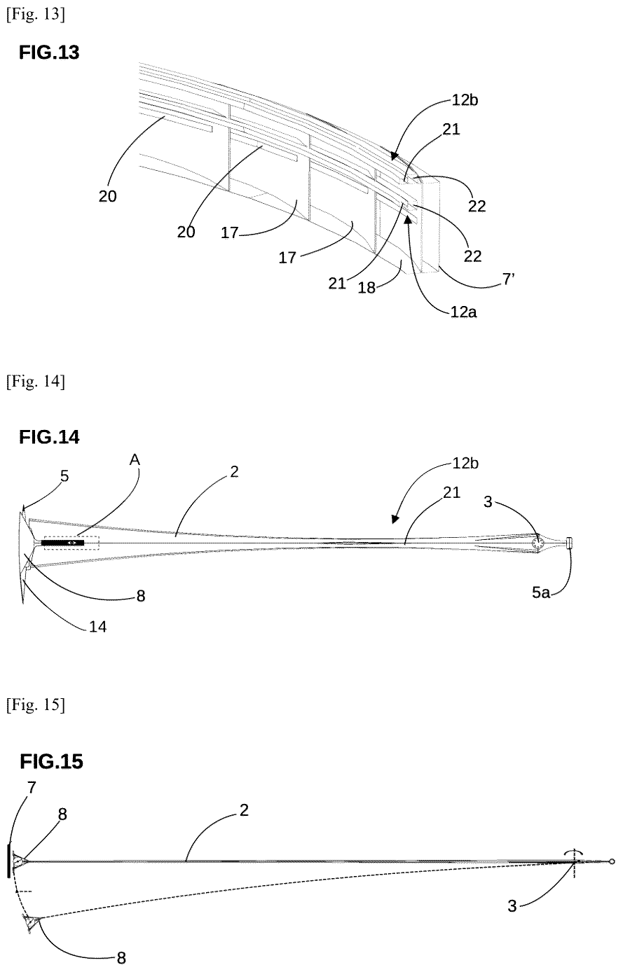

FIGS. 1 to 15 illustrate a device for launching a projectile that comprises a chamber 1. A rotation arm 2 is arranged in the chamber 1. The rotation arm 2 is mounted rotatable around a rotation shaft 3. The rotation arm 2 moves in rotation inside the chamber 1. The chamber 1 has an ejection port 4 allowing a projectile 5 to exit when the speed of the latter reaches the required value also called ejection speed.

The rotation arm 2 comprises a first end that is designed to support the projectile 5. The projectile 5 moves in the chamber 1 along a circular travel path. In preferential manner, the second end receives a counterweight 5a designed to counteract the forces induced by the projectile 5 attached to the first end. Preferentially, the rotation shaft 3 is fixed closer to the second end than to the first end.

The chamber 1 is associated with a pumping system 6 that enables the inside of the chamber 1 to be placed in a vacuum. The value of the pressure level in the chamber 1 is a function of the required level of performance. It is advantageous for the chamber 1 to be as tightly sealed as possible to limit the use of the pumping system 6 to achieve and maintain the required pressure value in the chamber 1. The pressure in the chamber is preferentially less than 10,000 Pa, more preferentially less than 1,000 Pa and even more preferentially less than 100 Pa.

The chamber 1 preferentially has a platform mounted movable with respect to a support. The support is fixed to the ground and the platform tilts with respect to the support so as to define a precise angle θ_0 that will impose the angle of ejection of the projectile with respect to the ground. The angle θ_0 is chosen such as to at least partly define the trajectory of the projectile 5.

The chamber 1 has a side wall 7 that is substantially of circular shape with the exception of the ejection port 4. When travelling circularly inside the chamber 1, the projectile 5 moves facing the side wall 7. The facing is observed in a radial direction YY defined by the longitudinal axis of the rotation arm 2. The radial direction YY is the direction relative to the rotational movement of the rotation arm 2 supporting the projectile 5.

More particularly, the launching device is provided with a pad 8 secured to the first end of the rotation arm 2. The pad 8 is designed for installation of the projectile 5. The pad 8 moves circularly in the chamber 1 facing the side wall 7 and the projectile 5 is installed in the pad 8. The pad 8 defines a cradle 9 designed to receive the projectile 5. The cradle 9 has a length in a first direction XX perpendicular to the radial direction YY and oriented in the direction of advancement of the pad 8, a width in a second direction YY perpendicular to the first direction and parallel to the rotational axis defined by the rotation shaft, and a height in a third direction ZZ perpendicular to the previous two directions, i.e. the radial direction. The second direction YY is parallel to the rotational axis defined by the rotation shaft 3. The cradle 9 has coupling and uncoupling means configured to couple the projectile 5 with the cradle 9 when the speed is lower than a target speed and to allow the projectile 5 to be uncoupled when the speed of the projectile reaches the target speed also called ejection speed.

In one embodiment, the pad 8 is fixedly secured to the rotation arm 2. In another embodiment, the pad 8 is installed movable with respect to the rotation arm 2 in the ZZ direction. It is advantageous for the pad 8 and the rotation arm 2 to define a slide link A in the ZZ direction. When the speed of rotation of the arm 2 is lower than a first threshold speed, the pad is not in contact with the side wall 7. When the speed of rotation of arm 2 reaches and exceeds the first threshold speed, the mechanical connection between the pad 8 and the arm 2 changes, and the pad 8 moves to press against the side wall thereby reducing the centrifugal forces induced by the pad 8. Partial uncoupling between the arm 2 and the pad 8 limits the inertial forces applied on the arm 2. In preferential manner, the pad 8 is connected to the rotation arm by means of a spring. As the speed progressively increases, the force applied by rotation of the pad 8 on the spring stretches the spring and the pad 8 moves until it comes into contact with the side wall. Once the threshold speed has been reached, the force applied by the pad on the spring becomes constant or substantially constant. Preferentially, the mechanical connection between the pad 8 and the rotation arm 2 via the spring is then eliminated by disconnecting the spring either from the rotation arm 2 or from the pad 8. An exemplary embodiment is illustrated in FIG. 14.

For the pad 8 to move inside the chamber 1, the pad 8 is provided with a nozzle 10 that is connected to a source of first gas 11. The source of first gas 11 supplies first gas to the nozzle 10. The first gas that is ejected from the nozzle 10 propels the pad 8 that rotates around the rotation shaft 3. Preferentially, the nozzle is a Laval nozzle thereby facilitating pressure relief of the gas to achieve a low final outlet pressure.

This embodiment is particularly advantageous as the force designed to make the pad 8 move is applied directly on the pad 8, thereby enabling a better efficiency to be achieved than rotation by means of a motor fixed to the rotation shaft 3. The nozzle 10 generates a thrust force that is applied directly on the pad 8, thereby enabling a launching device to be obtained that can withstand a friction force applied on the rotation arm 2 that is greater than the configurations of the prior art and in particular as regards the document U.S. Pat. No. 10,202,210.

In addition to the nozzle 10 associated with the source of first gas 11, it is possible to use an electric motor to perform the initial rotations of the pad 8. Once a minimum first speed has been reached, the electric motor is switched off and the pad 8 is moved solely by means of the first gas escaping from the nozzle 10. The electric motor that is used is less powerful and less heavy than the configurations of the prior art and in particular of the document U.S. Pat. No. 10,202,210. The nozzle 10 enables the pad 8 and therefore the projectile 5 to be accelerated up to the required speed. The nozzle 10 enables a much higher power to be developed than the central electric motor used in the prior art configurations and in particular in the document U.S. Pat. No. 10,202,210, thereby enabling the total duration of the acceleration cycle of the projectile 5 to be considerably reduced. This represents a real commercial advantage, as the launch frequencies can be increased.

The nozzle 10 is arranged in such a way that the first gas strikes the side wall 7 so that the jet outlet from the nozzle 10 pushes the pad 8. The first gas can be a neutral gas, an inert gas. It can also be air, for example the air coming from an inlet arranged near chamber 3. The source of first gas 11 advantageously comprises a compressor that sends the first gas to the nozzle 10 to move the pad 8. The compressor supplies the first gas with a flowrate and a pressure that enable for example a speed of more than 600 m/s, preferably more than 900 m/s, to be had at the outlet of the nozzle. The compressor can be configured to provide a pressure of more than 100 bars. In preferential manner, the source of first gas 11 is provided with a dehumidifier that reduces or eliminates the water from the first gas.

The pad 8 moves facing the side wall 7 along a track 12. In its rotational movement, the pad 8 presses on the side wall 7 so as to reduce the stresses applied on the rotation arm 2 in the radial direction ZZ. When rotation of the pad 8 takes place, a part of the forces applied on the rotation arm 2 is taken up by the side wall, thereby enabling a heavier projectile and/or a higher rotation speed to be used. The pad 8 runs along a track 12 to perform the stress take-up. The track 12 is preferentially in the form of a circle in an observation along the rotational axis YY of the rotation the arm 2. When the connection between the arm 2 and the pad 8 allows movement in the radial direction ZZ, a slight mobility between the arm 2 and the pad 8 in the radial direction ZZ enables the stresses applied on the arm 2 in the ZZ direction to be limited when the distance between the pad and the side wall changes due to the centrifugal force. This configuration can be able to take up all the stresses in the ZZ direction.

The use of a nozzle directly present on the pad to eject the first gas enables the friction forces between the track 12 and the pad 8 to be overcome, thereby making it possible to have an acceleration of the pad 8 up to the target speed or ejection speed compatible with ejection of the projectile 5. Such a contact is prohibited for the configuration according to the document U.S. Pat. No. 10,202,210, as the friction forces exceed the capacity of any electric motor available on the market.

To greatly reduce the centrifugal forces applied on the rotation arm 2 and to reduce the friction forces, the pad 8 and the track 12 define an aerodynamic bearing.

The aerodynamic bearing comprises a layer of second gas present between the track 12 and the pad 8. The second gas layer presents a pressure that is higher than the pressure in the chamber 1, preferably a pressure of more than 10 bars, i.e. 1,000,000 Pa. The second gas pressure artificially enables the pad 8 to press against the side wall 7 so that the side wall 7 takes up the effort of the pad 8. As the side wall 7 is a fixed or quasi-fixed part, it is possible to dimension the latter to withstand the stresses applied by the pad 8 through the aerodynamic bearing. The second gas pressure is preferentially greater than 10,001,300 Pa, more preferentially greater than 20,126,000 Pa and even more preferentially greater than 50,000,000 Pa.

At a standstill, it is advantageous for the pad 8 not to be in contact with the track 12. The distance between the track 12 and the pad 8 can be about a few centimetres, but it may go up to one or two metres when the pad has a mass of several tons with a large radius, for example 50 metres or more. When the pad 8 rotates around the rotation shaft 3 with a lower speed than a threshold minimum speed, the pad 8 is not in contact with track 12. Once the threshold minimum speed has been reached, the pad 8 is in contact with the track 12 or almost in contact with the track to form the aerodynamic bearing.

The aerodynamic bearing enables the pad 8 to slide along the side wall 7, pressing virtually against the side wall 7 without resulting in a too high friction force being generated. This enables the stresses applied on the rotation arm to be reduced thereby enabling the arm to be lightened. A given force of the first gas jet enables a projectile 5 times heavier to be driven. Simulations show that the more the pressure exerted by the pad 8 on the track 12 increases, the lower the dynamic friction coefficient. A dynamic friction coefficient of about 0.0045 can be achieved.

In operation, first gas is ejected from the nozzle 10 and second gas is generated to form the aerodynamic bearing. The pumping system 6 comes into operation when the pad 8 rotates around the rotation shaft 3. The pumping system 6 sucks the first gas and the second gas so as to maintain a low pressure level in the chamber 1. The performances of the pumping system 6 are chosen such as to suck up the quantity of first gas emitted by the nozzle 10 and the quantity of second gas emitted by the aerodynamic bearing.

In preferred manner, the source of first gas 11 is a source that is located outside the chamber 1. As illustrated in FIG. 4, the source of first gas 11 is connected to the pad 8 by a pipe that passes through the rotation shaft 3 and is fixed to the rotation arm 2. The source of first gas 11 is not a part that rotates around the rotation shaft 3. It is easy to use a source of first gas 11 that has a considerable mass. The first gas is supplied via a pipe presenting a mass that is limited. This enables the stresses on the rotation arm 2 to be reduced.

The source of first gas 11 is preferentially immobile with respect to the chamber 1 or with respect to the support. In one particular case, the source of first gas 11 is mounted in fixed manner to the chamber 1. In another particular case, the source of first gas 11 is mounted in fixed manner with respect to the support, i.e. with respect to the ground. Depending on the embodiments, the source of first gas 11 can comprise a compressor and/or bottles of first gas in compressed state. The source of first gas is an inexpensive means presenting an emission of harmful gases that is low or nil.

In a particular embodiment, the side wall 7 defines a bottom track 12a and a top track 12b located respectively facing a bottom plate 13a and a top plate 13b. Each of the two track/pad couples forms an aerodynamic bearing that enables the pad 8 to slide against the side wall 7. It is advantageous to separate the bottom track 12a and the top track 12b by a distance that is greater than or equal to the width of the cradle 9, which represents the maximum dimension of the projectile 5 in the YY direction as illustrated in FIG. 4. When the projectile 5 is ejected from the cradle 9, the projectile 5 passes between the bottom track 12a and the top track 12b to enter the ejection tube 4a and pass through the ejection port 4.

It is advantageous to arrange the nozzle 10 so as to eject the first gas against a face of the side wall 7 located between the bottom track 12a and the top track 12b in a direction perpendicular to the longitudinal axis of the rotation arm 2 (i.e. radial direction ZZ) and parallel to a direction of advancement XX of the pad 8 in chamber 1. This enables the thrust force to be better placed in the same rotational plane as the centre of gravity of the pad 8 and preferentially of the assembly formed by the pad 8 and the projectile 5. The rotational plane, under established rotation conditions, is perpendicular to the YY direction. In preferential manner, the centre of gravity of the projectile 5 and the neutral fibre of the rotation arm 2 belong to the same rotational plane perpendicular to rotational axis YY. More preferentially, the rotational plane is a plane of symmetry of the nozzle 10.

In a particular embodiment illustrated in FIG. 8, the bottom plate 13a and the top plate 13b define two non-parallel walls. The two outer faces of the bottom plate 13a and of the top plate 13b are not parallel and coplanar as could be expected. Preferentially, the two walls are misaligned with respect to one another to be secant in the rotational plane containing the neutral fibre of the rotation arm 2. Even more preferentially, the two plates 13a/13b define secant planes of convex shape starting from the rotation shaft 3. This configuration improves the stability of the pad 8 by applying a force that tends to recentre the pad 8 along the rotational plane defined by the neutral fibre of the rotation arm 2 when the latter moves at high speed. It is advantageous for arm 2 and the pad 8 to allow a slight movement with respect to one another in the YY direction when the two plates define the convex force. The pad 8 can self-adjust its position in the YY direction without applying stresses on the arm 2.

In an advantageous embodiment illustrated in FIG. 15, the rotation arm 2 sags in the YY direction due to the weight of the pad 8 and of the projectile 5. At a standstill, the pad 8 is not totally facing or is not facing the track or tracks 12. As the speed of rotation of the rotation arm 2 increases, the rotation arm 2 is deformed and the pad 8 moves in the YY direction to at least partially compensate the effect of gravity. It is particularly advantageous for the pad 8 to be facing the track 12 in order to reach the first threshold speed. The rotation arm 2 presents a flexibility in the YY direction that facilitates alignment of plates 13a/13b with respect to tracks 12a/12b with the plates defining a convex shape.

It is advantageous for the two plates 13a/13b to be thermally dissociated from the rest of the pad 8 by means of a thermally insulating layer, for example by means of a layer of cork.

In advantageous manner, the bottom track 12a and the top track 12b are elements that are salient from the side wall 7. More preferentially, the salient elements are solid elements thereby facilitating confinement of the first gas ejected by the nozzle 10. This enhances the efficiency of propulsion of the pad 8 by the first gas.

To improve the efficiency of propulsion of the pad 8 even further, the pad 8 has a discharge pipe 14 of the first gas that extends the nozzle 10 and confines the first gas jet. The nozzle 10 is directed so as to generate a flow of first gas that is perpendicular to the radial direction ZZ and parallel to the tangential velocity of the pad 8 so as to have a motor torque that is as pure as possible. The central axis of the first gas flow ejected by the nozzle 10 is included in the rotational plane defined by the neutral fibre of rotation shaft 2.

The discharge pipe 14 comprises two transverse walls that confine the first gas flow so that the entirety of the first gas escapes between the bottom track 12a and the top track 12b. The discharge pipe 14 has a wall that connects the two transverse walls and that prevents the first gas from being removed to the rotation shaft 3. This limits dissipation of the first gas in the chamber, thereby facilitating suction of the first gas by the pumping system 6.

The first gas flow is perpendicular or substantially perpendicular to the longitudinal axis ZZ of the rotation arm 2, and the discharge pipe 14 preferentially has a deflector 15 configured to divert the ejection axis of the first gas slightly with respect to the plane perpendicular to the radial direction ZZ passing through the central axis of the nozzle 10.

In preferential manner, the discharge pipe 14 is terminated by a gasket. The gasket is formed by a plate that extends beyond the nozzle 10 at the rear of the cradle 9 in the extension of the bottom plate 13a and the top plate 13b, to form where appropriate a first aerodynamic bearing with the bottom track 12a and a second aerodynamic bearing with the top track 12b. The two aerodynamic bearings work in the same way as those formed by tracks 12 and plates 13. The two aerodynamic bearings act as gaskets preventing a flow of first gas between the track 12 and the sheet 16. The two aerodynamic bearings extend the bottom plate 13a and the top plate 13b towards the rear of the nozzle 10, the front being represented by the head of the projectile 5. The plate defines an aperture 16a for removal of the first gas. In preferential manner, the plate and discharge pipe define a single through aperture for the first gas to pass.

In advantageous manner, the rear end of the gasket belongs to the plane perpendicular to the YY direction containing the central axis of the first gas flow ejected by the nozzle 10. When the nozzle 10 is of circular cross-section, this corresponds to the axis passing through the centre of the circle formed by the nozzle 10 and perpendicular to the radial axis ZZ. The aerodynamic bearings present a pressure that confines the first gas and prevents removal of the first gas between each track and the two lateral ends of the gasket.

The discharge pipe 14 is tightly sealed or substantially tightly sealed and the gasket defines an aperture 16a for removal of the first gas between the bottom track 12a and the top track 12b. In this way, the first gas that leaves the pad 8 is confined between the two salient tracks, the bottom of the side wall 7 and the gasket. The high-pressure aerodynamic bearing in association with the two salient tracks forces the first gas flow so that the latter only comprises a tangential or predominantly tangential component, thereby enhancing the energy efficiency of movement of the pad 8.

In preferential manner, the side wall is textured to improve the thrust of the pad 8 by the first gas jet. Advantageously, the side wall 7 comprises a plurality of fins 17 arranged on one another in the radial direction ZZ. Each pair of two consecutive fins partly delineates a tube connected to the pumping system 6. The fins 17 partially overlap one another in the radial direction ZZ.

In advantageous manner, each pair of two consecutive fins, the top track 12b and the bottom track 12a form a tube connected to the pumping system 6. The side wall 7 possesses a plurality of fins 17 that are offset from one another. The fins 17 are curved in concave manner away from the rotation shaft 3. Preferentially, the fins 17 have a radius of curvature that is smaller than the radius of curvature of the chamber 1, in particular smaller than that of the tracks 12a/12b.

In a particular embodiment, the chamber 1 has a casing 7′ that renders the chamber 1 tightly or almost tightly sealed. For the sake of clarity, the casing 7′ is not represented in FIGS. 1 to 3. The fins 17 press against the casing 7′ to ensure the good mechanical strength of the fins 17 that receive the first gas jet at high pressure. In preferential manner, the fins 17 are secured to the casing 7′ on the two opposite edges of the latter in the YY direction, for example they are secured to a bottom wall 18 and a top wall 19. It is also advantageous to provide for each fin 17 to have an extra thickness forming a reinforcement 20 which enables the shape of fin 17 subjected to the first gas jet to be better preserved.

In a particular embodiment where the chamber 1 is provided with a salient bottom track 12a and a salient top track 12b, the bottom track 12a and the top track 12b are arranged salient from the fins 17 with a variable thickness so as to form a circular track. The track arranged on the inner face of a fin 17 extends to support the outer face of the adjacent fin 17.

As the chamber 1 presents a considerable diameter, it is advantageous to perform pumping of the first gas and of the second gas by angular sector, i.e. over a portion of the circumference. It is advantageous to divide the circle into a plurality of angular sectors and to use a pump for each angular sector. There are as many pumps as angular sectors, for example four angular sectors or at least four angular sectors.

To form an aerodynamic bearing between the track 12 and the pad 8, a gas is present at high pressure thereby enabling a centripetal force to be applied on the pad 8. The first gas can be injected through the pad 8 to be facing the track 12. However, it is particularly advantageous for the inner end of the track 12 to be made from a sacrificial material 21 that is sublimated when a heat input takes place on account of the movement of the pad 8 with respect to track 12. Sublimation of the sacrificial material 21 forms the second gas. The sacrificial material 21 can be polycarbonate or polytetrafluoroethylene. The choice of sacrificial material is made according to the pressure value in the chamber 1 and the quantity of heat produced by the friction of the pad 8. Although the friction coefficient is low, the forces generated are high on account of the anticipated speed, for example 3000 m/s, and on account of the mass of the assembly formed by the pad 8 and the projectile 5, for example 3500 kg. Even with an aerodynamic bearing, the passage of the pad 8 generates a temperature rise of the sacrificial material 21.

When the pad 8 moves along the track 12, the temperature of the plate 13 and the track 12 rises. The more the speed increases, the more the temperature increases until the sacrificial material 21 sublimates. The high temperature associated with the small distance between plate 13 and the track 12 creates an aerodynamic bearing thereby reducing the friction forces present. To form the aerodynamic bearing more quickly, the track can be provided with heating, for example a heating by Joule effect with wires through which an electric current flows. The heating heats the sacrificial material below its sublimation temperature. Passage of the pad 8 generates a heat input necessary to achieve sublimation. A control circuit can be configured to adjust the quantity of heat applied by the heating according to the speed of the pad 8 and/or the mass of the projectile 5. The sublimation phenomenon is a phenomenon that is self-sustained by the different rotations performed by the pad 8.

Simulations show that, for a tangential speed equal to 3000 m/s and with a pad/projectile assembly having a mass equal to 2000 kg, the pressure in the aerodynamic bearing can reach 345 bars. When the mass is equal to 11,000 kg, the pressure in the aerodynamic bearing can reach 2000 bars. The rotation arm and pad define a length equal to 53.5 metres, which corresponds to the internal radius of the track. If the pressure is too high, it is possible to increase the length and/or width of the plate and of the track to increase the contact surface and reduce the pressure value.

The more the mass increases, the more the pressure increases. Such a pressure opposes the flow of first gas from the nozzle 10. The pressure of the aerodynamic bearing is a function of the facing surface between track 12, the plate 13, the mass of the assembly formed by the pad 8 and the projectile 5 and the tangential speed of the pad 8. The plate 13 and the sheet 16 can be made from metallic material, for example from stainless steel and from a ceramic.

In advantageous manner, the inner part of the track 12 is formed, and more preferentially each track 12 is terminated, by the sacrificial material 21. Such an embodiment makes it possible to limit the loss of thickness of the sacrificial material 21 when a rotation is performed in comparison with a plate 13 made from the sacrificial material 21. This enables a more stable separating distance to be had between plate 13 and the track 12 as the rotations take place. It is advantageous to install the sacrificial material 21 on a support pad 22. Once the sacrificial material has been totally consumed, more of the same is added to the support pad 22. It is also possible to add sacrificial material when a predefined quantity thereof has been consumed. The sacrificial material 21 is preferentially a material having a sublimation temperature comprised between −120° C. and 250° C. at the operating pressure of the chamber 1, i.e. when the pad 8 moves in the chamber 1. The sacrificial material is chosen such that the friction coefficient is preferentially between 0.05 and 0.2.

For example purposes, for an acceleration cycle of a duration of 30 minutes and with a pad 8 and a projectile 5 having a total mass of about 3800 kg, a loss of thickness of about 5 mm is estimated when the sacrificial material 21 is a polycarbonate present on the bottom and top tracks.

To compensate this increase of the inner diameter of tracks 12, it is advantageous to provide a pad 8 mounted movable in translation outwards in the radial direction ZZ. As the rotations are performed, a control circuit is configured to command an outward movement of the pad 8. It is possible to compute the loss of the sacrificial material 21 for each rotation made according to the mass of the projectile 5 and the speed, thereby enabling a movement of the pad to be achieved that is able to match the increase of the diameter of the track 12 rotation after rotation. It is possible to move the pad 8 in radial manner over a predefined number of rotations or when the control circuit detects a thickness decrease greater than a threshold value. As an alternative, arm 2 and the pad 8 have a mechanical connection that allows a slight movement in the radial direction ZZ. As the pad 8 is free to move in the ZZ direction with respect to the arm 2, the pad 8 adjusts its position automatically to match the thickness of the track 12.

The use of the sacrificial material 21 is preferable to the use of the first gas to form the aerodynamic bearing. The sacrificial material 21 enables a more homogeneous distribution of the gas forming the aerodynamic bearing to be had. This avoids for example having to pierce the plate to inject gas and makes for a more homogeneous operation as regards the acceleration phases where the consumption of first gas varies.

The control circuit can also control movement of the pad 8 in the direction of the track 12 when the threshold minimum speed is reached.

The pad 8 provided with the projectile 5 rotates in the chamber 1 with an acceleration. When the speed reaches the required speed, the pad 8 ejects the projectile 5 that exits the chamber 1 via the ejection port 4. The ejection port is preferentially formed by a sacrificial film that maintains the low pressure and is torn when the projectile 5 passes through. The projectile 5 can be a satellite equipped with a booster. The booster is activated once the satellite has reached a threshold altitude or after a predefined time after leaving the pad. When ejection takes place, the radial acceleration is about 16,681 g.

The method for launching can comprise the following steps:
providing a launching device according to the foregoing configurations;
securing the projectile to the pad;
reducing the pressure in the chamber;
driving the pad in rotation until a threshold ejection speed is reached;
releasing the projectile so that the projectile exits the launching device with the threshold speed through an ejection port.

When the pad is brought into contact with the track or tracks, the speed of the pad decreases slightly due to the modification of the driving conditions, and the speed then increases again when the aerodynamic bearing is created.

The method for launching can be used to send a projectile into space, for example to place a satellite, for example a geostationary satellite. It is also possible to use such a launching method to send freight over long distances very rapidly, to connect two points on earth.

The projectile can be provided with a booster that is able to generate a thrust enabling the projectile to reach the selected orbit and/or to modify its path. The launching device enables a saving to be made on a large part of the fuel to be embarked.

1-18. (canceled)

19. Device for launching a projectile comprising:
a chamber provided with a side wall and an ejection port;
a rotation arm mounted rotating around a rotation shaft, the rotation arm being arranged to rotate around the rotation shaft in the chamber, the rotation arm extending in a radial direction;
a pad mounted on a first end of the rotation arm and designed to receive the projectile, the pad moving with a circular movement in the chamber;
a pumping system configured to place the inside of the chamber in a vacuum;
wherein the pad comprises a nozzle connected to a source of first gas, the nozzle ejecting a flow of first gas directed to make the pad advance with a circular movement inside the chamber;
wherein the side wall defines at least one track designed to support the pad in the radial direction; and
wherein the at least one track, the pad and a second gas define an aerodynamic bearing between the at least one track and the pad so that the at least one track takes up at least a part of the efforts of the pad in the radial direction.

20. Device for launching a projectile according to claim 19 wherein the source of first gas is a source located outside the chamber and connected to the pad by a pipe fixed to the rotation arm.

21. Device for launching a projectile according to claim 20 wherein the source of first gas is arranged immobile with respect to the chamber or immobile with respect to a support supporting the chamber.

22. Device for launching a projectile according to claim 20 wherein the source of first gas comprises a compressor configured to eject the first gas at a pressure at least equal to 10⁶ Pa.

23. Device for launching a projectile according to claim 19 wherein the side wall defines a bottom track and a top track separated from one another in a direction parallel to a rotational axis of the rotation arm defined by the rotation shaft, and wherein the nozzle is arranged to eject the first gas against a surface located between the bottom track and the top track.

24. Device for launching a projectile according to claim 23 wherein the pad comprises a bottom plate and a top plate running respectively facing the bottom track and the top track along the radial direction, the bottom plate and top plate defining two secant, non-parallel walls of convex shape starting from the rotation shaft.

25. Device for launching a projectile according to claim 24 wherein the rotation arm is flexible in a parallel direction to the rotational axis of the rotation shaft.

26. Device for launching a projectile according to claim 23 wherein the bottom track and the top track are salient tracks of the side wall that delineate a confinement groove of the first gas outlet from the nozzle.

27. Device for launching a projectile according to claim 26 wherein the pad comprises a bottom plate and a top plate running respectively facing the bottom track and the top track, the pad having a sheet extending continuously from the bottom track to the top track.

28. Device for launching a projectile according to claim 26 comprising a discharge pipe of the first gas that extends the nozzle and that confines the jet of first gas, the nozzle being directed so as to generate a flow of first gas that is perpendicular to the radial direction, a central axis of the flow of first gas ejected by the nozzle being included in the plane defined by a neutral fibre of the rotation arm.

29. Device for launching a projectile according to claim 28 comprising a sheet fixed to the discharge pipe to enclose the nozzle, the sheet covering the bottom track and the top track to form an additional first aerodynamic bearing with the bottom track and an additional second aerodynamic bearing with the top track, the sheet defining an aperture for removal of the first gas.

30. Device for launching a projectile according to claim 23 wherein the side wall comprises a plurality of partially overlapping fins, and wherein each pair of two consecutive fins, the top track and bottom track form a tube connected to the pumping system.

31. Device for launching a projectile according to claim 19 comprising a generator of second gas that is the generator of first gas, and wherein a part of the flow of first gas is directed between the pad and the track.

32. Device for launching a projectile according to claim 19 wherein one of the pad and the track is covered by a sacrificial material sublimating the second gas in response to a heat input originating from running of the pad facing the track.

33. Device for launching a projectile according to claim 23 wherein the bottom track and the top track are covered by a sacrificial material sublimating the second gas in response to a heat input originating from running of the pad facing the bottom track and the top track.

34. Device for launching a projectile according to claim 33 wherein the sacrificial material is a polytetrafluoroethylene or a polycarbonate.

35. Device for launching a projectile according to claim 19 wherein the rotation arm and the pad form a mechanical connection allowing movement of the pad with respect to the rotation arm in a radial direction of the rotation shaft.

36. Method for launching a projectile comprising the following steps:
providing a device for launching according to claim 19;
securing the projectile to the pad;
reducing the pressure in the chamber;
driving the pad in rotation until the threshold ejection speed is reached;
releasing the projectile so that the projectile exits the launching device with the threshold speed through an ejection port.
